(19) United States
(12) Patent Application Publication
(10) Pub. No.: US 2013/0043315 A1
(43) Pub. Date: Feb. 21, 2013

(54) RFID tag with open-cavity antenna structure

(71) Applicants: William N. Carr, Montclair, NJ (US); James R. Cooper, Atlanta, GA (US)

(72) Inventors: William N. Carr, Montclair, NJ (US); James R. Cooper, Atlanta, GA (US)

(21) Appl. No.: 13/136,979

(22) Filed: Aug. 17, 2011

(51) Int. Cl. G06K 19/077; H01Q 1/50

(52) U.S. Cl. 235/492; 343/861

(57) ABSTRACT

A tag for a radio frequency Identification RFID system that comprises an open cavity with an integral load element. The load element is comprised of an impedance matching network and a load circuit. The load circuit contains one or more of an RFID transponder, microcontroller, capacitive sensor circuit, resistive sensor circuit, complex impedance sensor circuit, and an RF energy scavenging circuit in specific implementations. In various embodiments the tag includes reflector elements which enable the antenna structure to better tolerate the presence of nearby metal objects and provide electromagnetic gain.

### FIELD OF THE INVENTION

The present invention relates to antenna design for radio communication in general and more particularly, to antenna design for radio-frequency Identification (RFID) systems.

### BACKGROUND OF THE INVENTION

Radio communication systems have existed for over a century. During this period of time antenna designers have generated a wide variety of antenna designs with the goal of achieving good performance in a variety of operating conditions including a wide array of form factors. In more recent times with the development of further miniaturization of low power load circuits, a great need has developed for further miniaturization of antennas with considerations required for increased bandwidth and efficiency. Generally, a goal for the RFID tag designer is to produce a transponder tag that presents at least a minimum voltage level for powering an integral load circuit with further considerations to provide acceptable impedance matching between the antenna and an associated load element.

In the case of cavity antenna structures subject of the UHF embodiment of the present invention, the optimum impedance levels available directly from the cavities are often far removed from traditional 50 or 72 ohm resistive impedance levels. The load impedance presented by semiconductor load circuits in an RFID tag is different from traditional fixed resistive values. Therefore for RFID tags the inclusion of an impedance matching network within a load element is usually very important for achieving maximum range performance in an RFID design.

In traditional antenna design, the load element with its transmission line connected is designed to produce a minimum of radiation because this is generally an uncontrolled radiation pattern and efficiency. An example of this is shown in FIG. 1 prior art with a patch conductive radiator 100 positioned over a ground plane110. The patch radiator is connected to the center conductor of a coaxial cable 120. The antenna patch structure is designed to provide a resistive impedance to the coaxial cable thereby eliminating the need for a local impedance matching network. This is different from RFID tag designs where there is no transmission line and the source or load circuit is co-located with the antenna and in some cases the load circuit becomes part of the radiator. In the design of the present invention, for the UHF embodiment the tag RF radiation can originate from both the cavity and the load element coupled together electromagnetically. In the present invention, UHF radiation can also originate from load circuits contained within the load element. These facts guide the RFID tag design of the present invention which does achieve important advantages of increased radiation efficiency and miniaturization by including radiation structures within the load element.

It is well known in the art that antennas are reciprocal devices, meaning that an antenna that is used as a transmitting antenna can also be used as a receiving antenna, and vise versa. Furthermore, there is a one-to-one correspondence between the behavior of an antenna used as a receiving antenna and the behavior of the same antenna used as a transmitting antenna. This property of antennas is known in the art as “reciprocity”.

In this invention we describe an RFID tag that utilizes an open cavity structure with an integral complex impedance load element with load circuits providing fully-passive, semipassive, and active RFID functions. This invention tag also provides for a radio receiver within the load circuit comprised of such devices as a local graphics display controlled by modulated RF energy incident on the tag. The load circuit may contain one or more of elements such as a controller device for sensing an impedance modulated by humidity, shock, sound, and other environmental parameters.

### SUMMARY OF THE INVENTION

Embodiments of the present RFID tag invention comprise an open cavity with parallel plates directly connected to a load element. The cavity is realized using plates of conductive material such as, for example, metal foil. The open cavity at its self resonance presents a source impedance to the load element that is higher than prior-art antennas. A load element is connected between two edges of the two plates to make an RFID tag. The two plates are separated by various materials and media such as polystyrene, polyethylene, polycarbonate, ethylene vinyl acetate, silicon dioxide, PTFE, PET, PETG, Duroid, vacuum, intrinsic semiconductor including silicon, air, or vacuum. The load element includes a load circuit comprised of one or more of the following: a CMOS RFID protocol circuit, microcontroller, capacitive sensor circuit, resistive sensor circuit, complex impedance sensor circuit, and an RF energy scavenging circuit.

We define a major structural axis may be defined within the open cavity tag. The length of this major axis is between 10 meters and 10 micrometers in length covering selected frequency bands 20 MHz to 3 THz. Generally, this major structural axis determines a self-resonance frequency for the open cavity. The effective electromagnetic length of the tag may be more or less than the length of the major structural axis due to coupling with the load element and permittivity of integral or nearby structures. The separation between the parallel plates is generally no more than 10 percent of the physical length of the tag.

The conductive plates of the open cavity may be configured into various shapes. In one embodiment the plates are rectangular. In another embodiment the plates are circular. In other embodiments the plates may be variously shaped to influence operating frequency, bandwidth, polarization, and overall radiation efficiency for the RFID tag.

An embodiment of the present invention comprises two rectangular plates of conductive material such as aluminum of foil thickness 0.2 mm and identical size arranged in a parallel fashion one over the other. The planer rectangular plates typically have a length to width aspect ratio of at least 4 to 1. A load element port with separate connections to edge of the respective plates and at the midpoint of the edge presents a source impedance of several thousand ohms resistive at cavity self-resonance. The impedance of the typical load circuit is in the range Z=20-j200 Ohms. In the present invention we use a load element to match the impedance levels of the cavity to the load circuit. This is generally accomplished in the present invention by operating the antenna into a frequency band different from the self-resonance of the antenna alone. Prior art open cavity antennas have been operated at or near the cavity self resonance frequency.

Typical matching networks used in the load element include the well known T-match network familiar to those skilled in the art. The matching network is comprised of inductors and capacitors which during operation of the RFID tag provide limited amount of radiation and thus importantly influence the design for optimum tag design. For instance, radiation structures contained within the load element can shorten the required length of a cavity antenna operating at a particular frequency band.

The RFID tag radiation pattern is affected by nearby metal structures and surfaces. A conductive ground plane can be used to enhance reflection from said plane and thus provide gain in a direction normal to the ground plane. When the present open cavity tag is mounted above a parallel plane of metal an enhanced gain in the normal vector direction away from the ground plane is obtained. When the present open cavity tag is mounted near a vertical plane of metal an enhanced gain in the normal vector direction away from the ground plane is also obtained. The use of a ground plane positioned nearby the open cavity RFID tag can be used to customize the radiation pattern in particular to increase the gain in a desired direction. The ground plane may be external or it may be part of the RFID tag case enclosure.

The load circuit within the load element determines whether the tag operates as a fully-passive, semipassive, or active RFID tag type. The details of these three tag types are well known to those skilled in the art. This invention provides for a selection of one or more of these three RFD tag types. A fully-passive RFID tag load circuit is powered from incident RF electromagnetic energy received usually from an external RF beacon or reader device. A semipassive RFID tag load circuit can be partially powered from either incident RF electromagnetic energy or from an integral battery or other power source or both. Both the fully passive and the semipassive RFID tag communicate wirelessly from the tag to an external reader by launching a backscattered modulated electromagnetic wave which is received by and decoded in the external reader.

An active RFID tag load circuit contains an integral source of local power such as a battery and is not powered via RF energy scavenged from incident electromagnetic energy. The present invention with an active load circuit contains a radio receiver to receive wireless data and a transmitting power source for communicating with the external reader.

Alternatively, the load circuit may contain only an RF-to-DC converter circuit typically a Schottky diode voltage multiplier or an MOS diode voltage multiplier providing power for a local tag function such as powering a micropower LCD display, LED display, or other passive transducer devices with control data provided by demodulating the incident RF carrier energy from a beacon or reader source.

The present invention is an RFID tag which includes open cavity structures and an integral load element that is unique in structure and operation compared with prior art.

### BRIEF DESCRIPTION OF THE DRAWINGS

FIG. 1 Patch antenna with coaxial cable (prior art)

FIG. 2(a) Embodiment 1 Isometric view of RFID tag comprised of a rectangular cavity

FIG. 2(b) Embodiment 1 RFID tag radiation pattern in free space

FIG. 2(c) Embodiment 1 Isometric view of RFID tag comprised of multiple reflecting planes

FIG. 3 Embodiment 2 RFID tag radiation pattern with nearby reflector in the xy plane.

FIG. 4 Embodiment 3 RFID tag radiation pattern with nearby reflector in the xz plane

FIG. 5 Embodiment 4 Isometric view of RFID tag comprised of a circular cavity

### DETAIL DESCRIPTION OF THE INVENTION

In the description of this invention numerous specific details are given to provide an understanding of embodiments. One skilled in the relevant art will recognize however that the embodiments can be practiced without one or more of the specific details, or with other methods, components, materials, etc. In other instances, well-known structures, materials, or operations associated with RFID tags and RFID readers are not shown or described in detail to avoid obscuring aspects of the embodiments.

Unless the context requires otherwise, throughout the specification and claims which follow, the word “comprise” and variations thereof, such as, “comprises” and “comprising” are to be construed in an open, inclusive sense, that is as “including but not limited to”. Reference through this specification to “one embodiment” or “an embodiment” means that a particular feature, structure, or characteristic described in connection with the embodiment is included in at least one embodiment. Thus, the appearances of phrases “in one embodiment” or “in an embodiment” in various places throughout this specification are not necessarily all referring to the same embodiment. Furthermore, the particular features, structures, or characteristics may be combined in any suitable manner in one or more embodiments.

Reference through this specification and claims to “radio frequency” or RF includes wireless transmission of electromagnetic energy including but not limited to energy with frequencies or wavelengths typically classed as falling the radio, ultrahigh, and superhigh portions of the electromagnetic spectrum.

Embodiment functions referred to as “UHF” include structures that can be scaled with appropriate fabrication technologies to include frequency bands ranging up to as high as 3 THz.

As an overview, an embodiment provides a data carrier such as an RFID tag having an open-cavity antenna and a load element. The antenna and all or part of the load element in one embodiment is a flexible inlay and can be folded to provide a more compact form factor and to facilitate assembly into an RFID tag structure. The flexible inlay in one embodiment can be attached to a dielectric and then placed in a rigid enclosure or coated with a special material to provide a rigid RFID tag such as a metal mount RFID tag that can be affixed to a metallic object or other object.

In one embodiment a metallic ground plane (such as provided by a metalized label) can be provided inside the rigid enclosure or inside some other protective structure (such as a coating) to serve as electrical shield or RF reflecting shield to minimize the effect of external objects on the antenna. The antenna of one embodiment can be provided with several resonant frequencies and is further able to operate according to different frequency bands, standards/protocols, applications, etc. Such embodiments of the RFID tag having the antenna inlay structure thus provides improved and increased capabilities and flexibility compared to existing RFID tags.

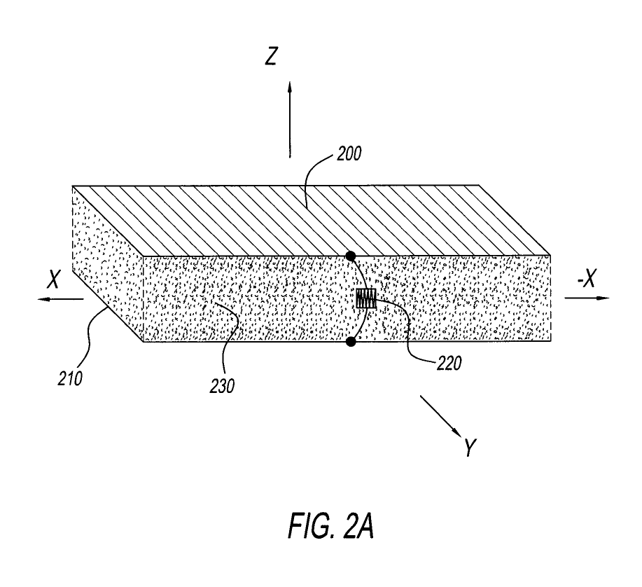

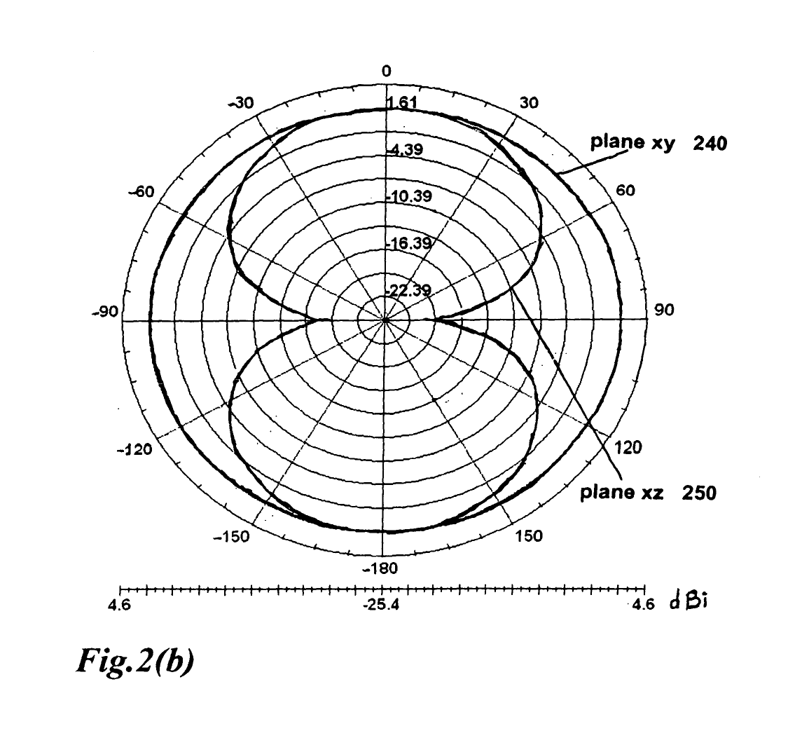

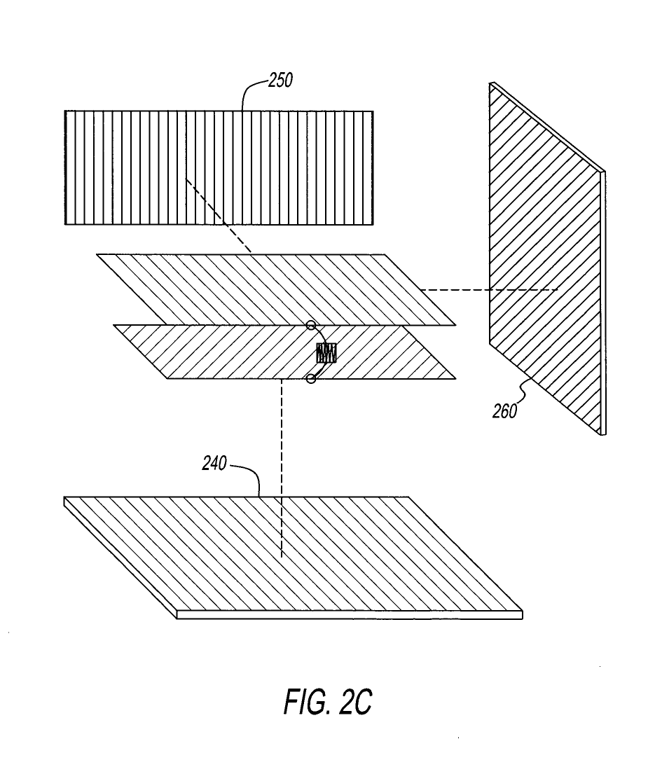

FIG. 2(a) is an isometric view of embodiment 1 where two parallel conducting plates are positioned opposite each other with a dielectric in between to form a rectangular solid. A first surface plate 200 is positioned above a second surface plate 210 with a load element 220 connected between the two plates. The dielectric material 230 has mechanical stability to maintain the separation between the two plates at a fixed value even though the entire structure may be nominally flexible. In normal operation electric and magnetic fields exist in the media between the two plates excited by incident RF energy from an external reader. A load element 230 is directly connected between two edges of the conducting plates at a first port typically located at or near the midpoint along the longer dimension (x-axis) of the structure. Other vector axes are defined as the y-axis and the z-axis. The approximate pattern from this embodiment is a field of uniform strength in the xy plane with a null along the y-axis.

FIG. 2(b) shows the computed radiation field intensity in the xz and yz planes for this embodiment operating in open air. In the example described a design for operation at 915 MHz has parallel plates each measuring 10 Omm×134 mm separated by a material of relative dielectric constant 1.1 and thickness 5.5 mm the maximum RF gain of the RFID tag is 1.61 dBi.

FIG. 2(c) shows other embodiments comprised of the rectangular central tag structure of FIG. 2(a) with conducting reflecting planes positioned in the three orthogonal planes xy 240, xz 250 and yz 260 surrounding the rectangular primary body of the RFID tag. The reflecting metal planes may be integral to the enclosure for the RFID tag or they may be external such as the metallic skin of a trash dumpster. In a typical embodiment the RFID tag will be used with only a single reflecting plane.

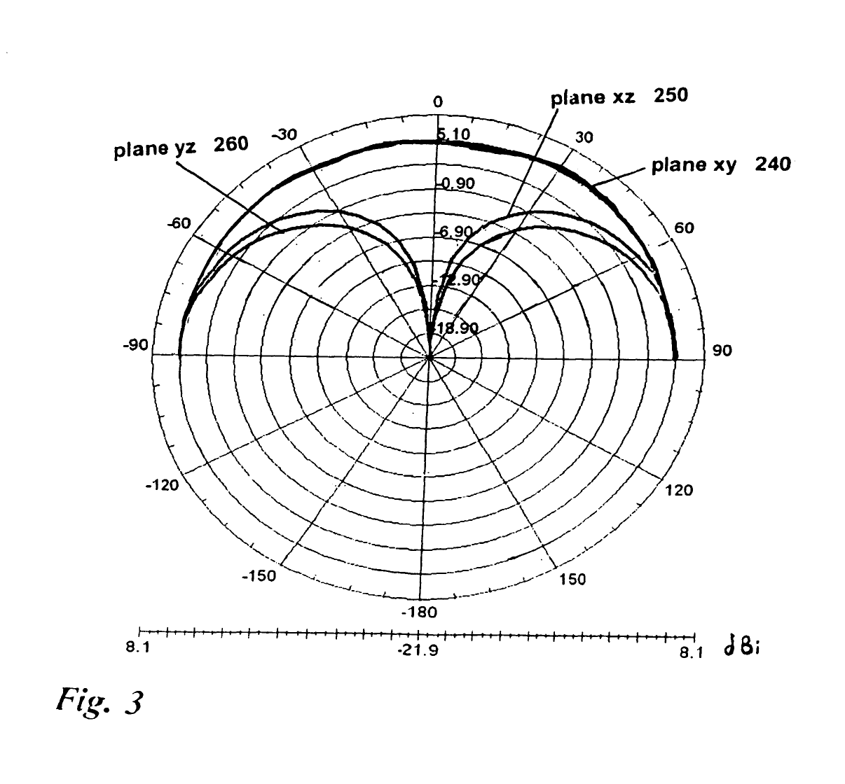

FIG. 3 shows the computed radiation pattern of an embodiment with a reflecting horizontal plane positioned directly below the rectangular plates at a distance of 35 mm. The reflecting plane in this embodiment has dimensions in the x and y directions much greater than a wavelength. When the reflector is configured together with the same central tag dimensions as the tag used for FIG. 2(b), the radiation pattern of this structure has a maximum gain of 5.1 dBi at 915 MHz.

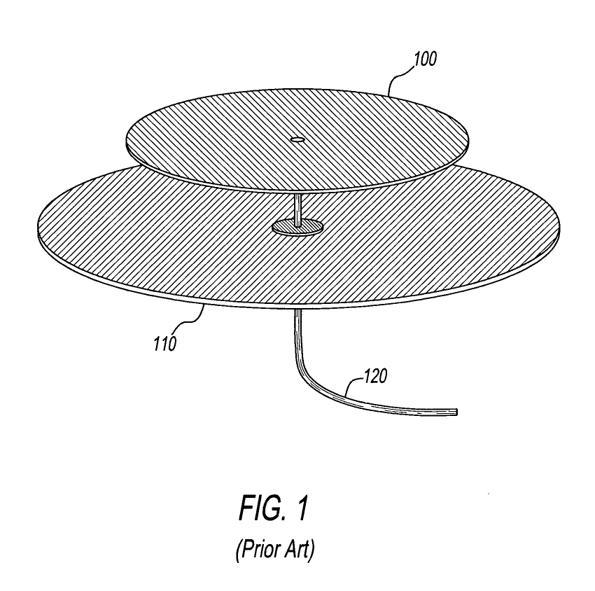

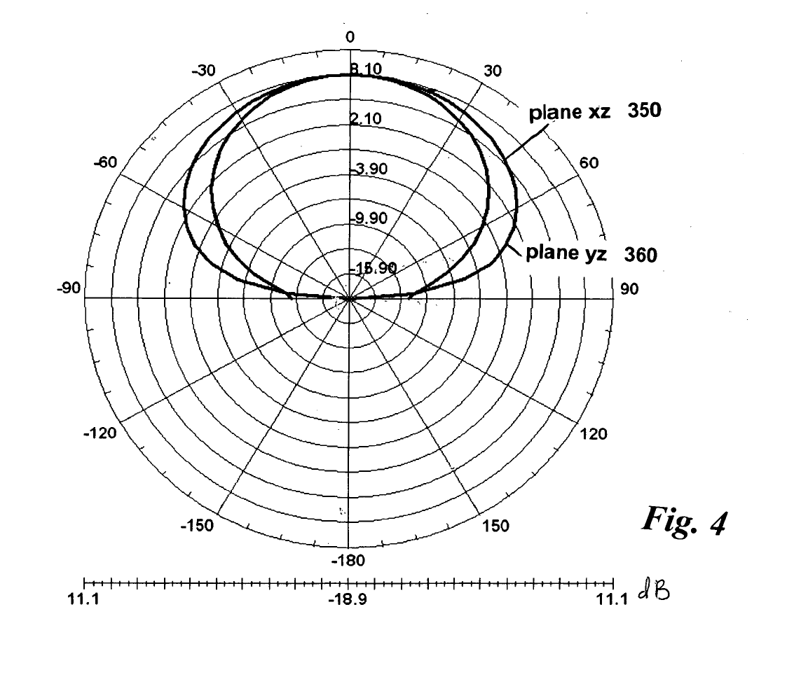

FIG. 4 shows the computed radiation pattern of an embodiment with a reflecting horizontal plane positioned in the xz plane directly to the side next to a rectangular cavity of FIG. 1. The xy conductive plane in this illustrative case has planer dimensions much larger than a wavelength. The distance between the reflecting plane and the rectangular cavity in this case is 35 mm. When this reflector is configured together with the tag and dimensions of FIG. 2, the radiation pattern of the structure has a maximum gain of 8.1 dB at 915 MHz.

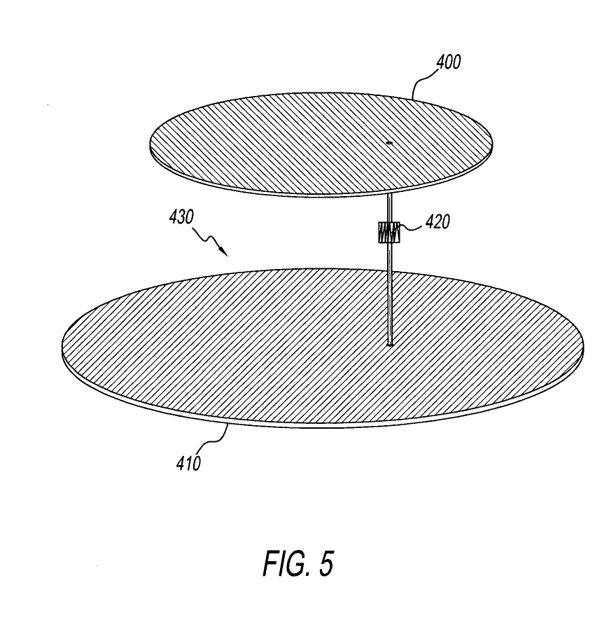

FIG. 5 shows an isometric view of another embodiment where the conductive plates of the primary structure are circular and positioned directly in opposition to each other and in parallel planes. In this embodiment a first surface plate 400 is positioned above a second surface plate 410. A load element 420 is directly connected to the two plates through a first port. There is a dielectric media 430 positioned between the two conductive plates to provide mechanical strength to the structure in addition to providing features such as a desired dielectric constant. The load element is comprised of an impedance matching network and a load circuit. The first port may be located across any two points between the two plates. For instance, the first port may be located across the plates at a position removed from the plate edges to provide a means for obtaining circularly polarized radiation from the RFID tag. A diameter vector in the plane of the parallel conductive plates is considered to be the primary axis. In a typical application the diameter of the plates is approximately a half wavelength and the plates are separated by a distance of less than 1/10 wavelength.

What is claimed is:

1. A radio frequency antenna comprising:
a first conductive plate in a first plane
a second conductive plate in a second plane that is parallel to the first plane and with a first port of a load element connected between the two plates with the first conducting plate having a defined major axis planer dimension.
wherein the first port of the load element is connected directly between the first and second plates
wherein the load element is comprised of an impedance matching network and a load circuit with the network providing a complex impedance match between the first port and the load circuit
wherein the structure is tuned to a desired frequency band by a matching of the complex impedance at the first port presented by the open cavity and the complex conjugate impedance presented by the load element
wherein the volume between the first and second plates is filled with a dielectric material, air, or vacuum space.
and wherein the conductive plates and all of or a portion of the load element constitute an RF radiative structure

2. An RFID tag comprising:
a first conductive plate in a first horizontal plane
a second conductive plate in a second plane that is parallel to the first plane and with a first port of a load element connected between the two plates with the first conducting plate having a defined major x-axis planer dimension and two minor orthogonal axes y and z.
where the first port of the load element is connected directly between the first and second plates
where the load element is comprised of an impedance matching network and a load circuit with the network providing a complex impedance match between the first port and the load circuit
wherein the tag is tuned to a desired frequency band by a matching of the complex impedance at the first port presented by the open cavity and the complex conjugate impedance presented by the load element
wherein the conductive plates and all of or a portion of the load element constitute an RF radiation structure
wherein the load circuit is comprised of one or more of a CMOS RFID protocol circuit, microcontroller, capacitive sensor circuit, resistive sensor circuit, complex impedance sensor circuit, and an RF energy scavenging circuit,

3. The RFID tag of claim 2 where the first and second conducting plates are rectangular in shape positioned opposite one another with the load element positioned at or near the midpoint of the major axis.

4. The RFID tag of claim 2 where the first and second conducting plates are circular or ellipsoidal in shape.

5. The RFID tag of claim 2 functioning as a fully-passive, semipassive, or active RFID tag and which additionally may or may not communicate back to a reader or readers.

6. The RFID tag of claim 5 comprised of one or more transducer devices such as a graphics display within the load circuit

7. The RFID tag of claim 2 comprised of a controller device for sensing an impedance modulated variously by but not limited to humidity, shock, sound, and other environmental parameters.

8. The RFID tag of claim 2 where the electrical length of the cavity across the major axis is a half wavelength for the operational frequency band

9. The RFID tag of claim 2 where the major axis is between 10 meters and 10 micrometers in length covering selected frequency bands 20 MHz to 3 THz

10. The RFID tag of claim 2 where the spacing between the conducting plates is less than one tenth of a wavelength

11. The RFID tag of claim 2 where the dielectric space between the plates is filled with one or more of various materials and media including but not restricted to polystyrene, polyethylene, polycarbonate, ethylene vinyl acetate, silicon dioxide, PTFE, PET, PETG, Duroid, vacuum, intrinsic semiconductor including silicon, air, or vacuum space.

12. The RFID tag of claim 2 where the first and second plates are comprised of aluminum, copper, nickel, printed conductive ink, conductive nanotubes or other conductive structures.

13. The RFID tag of claim 2 with one or more reflecting orthogonal planes xy, xz, and yz defined by the coordinate axes x, y, z and located nearby to the first and second plates.

14. The RFID tag of claim 2 where the reflecting plane or planes are part of a housing structure
